(19) United States
(12) Patent Application Publication
(10) Pub. No.: US 2018/0364708 A1
(43) Pub. Date: Dec. 20, 2018

(54) AUTOMATED VEHICLE ROUTE TRAVERSAL CAPABILITY

(71) Applicant: GM GLOBAL TECHNOLOGY OPERATIONS LLC, Detroit, MI (US)

(72) Inventor: MICHAEL A. LOSH, ROCHESTER HILLS, MI (US)

(73) Assignee: GM GLOBAL TECHNOLOGY OPERATIONS LLC, Detroit, MI (US)

(21) Appl. No.: 15/625,086

(22) Filed: Jun. 16, 2017

(51) Int. Cl. G05D 1/00; G05D 1/02; B60W 10/04; B60W 10/10; B60W 10/18; B60W 10/20; B60W 40/08; G08B 25/01

(52) U.S. Cl. CPC G05D 1/0061; G05D 1/0221; B60W 10/04; B60W 10/10; B60W 10/18; B60W 10/20; B60W 2540/26; G08B 25/016; B60W 2040/0818; B60W 2420/42; B60W 2420/54; B60W 2420/20; B60W 40/08

(57) ABSTRACT

Methods and apparatus are provided for controlling a vehicle. The apparatus includes an operator monitoring system configured to monitor an operator of the vehicle for a temporary incapacity, and an autonomous driving system configured to operate the vehicle in a temporary autonomous operation mode. A manual driving system is provided to operate the vehicle in a manual mode and a mode determination system is provided to transition a current mode of the vehicle between the temporary autonomous operation mode and the manual mode based on the temporary incapacity.

### TECHNICAL FIELD

The technical field generally relates to vehicle control, and more particularly relates to systems and methods for controlling a vehicle during temporary incapacitating fits.

### INTRODUCTION

A vehicle may be operated manually or autonomously. However, it may be possible to change between these modes of operation in accordance with current needs. For example, an autonomous operation mode may be started by an operator or driver of the vehicle.

An autonomous vehicle is a vehicle that is capable of sensing its environment and navigating with little or no user input. An autonomous vehicle senses its environment using one or more sensing devices such as radar, lidar, image sensors, and the like. The autonomous vehicle system further uses information from global positioning systems (GPS) technology, navigation systems, vehicle-to-vehicle communication, vehicle-to-infrastructure technology, and/or drive-by-wire systems to navigate the vehicle.

Vehicle automation has been categorized into numerical levels of automation ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

Accordingly, during operator incapacitation, it may be desirable to define specific conditions for automatically starting and ending temporary autonomous operation of a vehicle. Furthermore, other desirable features and characteristics of the present invention will become apparent from the subsequent detailed description and the appended claims, taken in conjunction with the accompanying drawings and the foregoing technical field and background.

### SUMMARY

A controller is provided for controlling a vehicle. In one embodiment, the controller includes an operator monitoring system configured to monitor an operator of the vehicle for a temporary incapacity, and an autonomous driving system configured to operate the vehicle in a temporary autonomous operation mode. The controller includes a manual driving system configured to operate the vehicle in a manual mode, and a mode determination system configured to transition a current mode of the vehicle between the temporary autonomous operation mode and the manual mode based on the temporary incapacity.

In various embodiments, the operator monitoring system detects reactions of the operator and determines if the reaction temporary incapacitates the operator. The operator monitoring system further generates an operator incapacitation trigger signal for autonomous intervention and transmits the operator incapacitation trigger signal to the mode determination system if the operator is incapacitated. The mode determination system initiates an autonomous operation mode of the vehicle if the mode determination system receives the operator incapacitation trigger signal and ends the autonomous operation if the operator incapacitation trigger signal ends and if the operator assumes manual control of the vehicle.

In various embodiments, the autonomous driving system determines if an intended route of the vehicle is present and follows the intended route if it is present or, otherwise, brings the vehicle to a predetermined state if there is no intended route present.

In various embodiments, the autonomous driving system determines if the intended route is explicitly set or to imply the intended route based on past driving patterns.

In various embodiments, the autonomous driving system determines a driving context and brings the vehicle to a predetermined state based on the determined driving context.

In various embodiments, the operator monitoring system includes at least one sensor of a group of operator monitor sensors consisting of: a microphone, a camera, a steering feedback sensor, wherein the at least one sensor is positioned to detect operator reactions onboard the vehicle.

In various embodiments, the operator monitoring system includes at least two microphones positioned and configured to enable detecting a position of a noise source for distinguishing between different possible operator positions.

In various embodiments, the operator monitoring system detects operator incapacitation based on a signal of the at least one sensor.

In various embodiments, the operator monitoring system repeatedly generates the operator incapacitation trigger signal if the operator is incapacitated and the mode determination system initiates the autonomous operation mode after a predetermined trigger repetition or after a predetermined trigger duration.

In various embodiments, the autonomous driving system generates a call for assistance signal and transmits the call for assistance signal to a communication system after bringing the vehicle to the predetermined state and if the operator incapacitation trigger signal is still present for a predetermined time duration or if the operator does not respond within the predetermined time duration.

In various embodiments, the controller described above and hereinafter recognizes and deals with short-duration incapacitation (temporary incapacity) of an operator or driver of a vehicle, e.g., short-duration fits of sneezing or other involuntary reactions that may temporarily incapacitate the driver to the extent that continuing manual operation of the vehicle is affected in an undesired manner. In various embodiments, a vehicle capable of SAE Level 2 autonomous operation or higher automatically assumes temporary autonomous operation when and as long as the incapacitation is detected and if various enablement conditions are met (for example, driver opt-in, autonomous equipment is healthy and functional, etc.).

In various embodiments, the controller and its function leverage existing equipment and features in additional scenario(s) and enable assuming autonomous operation and ending autonomous operation if manual operation is resumed. The need for intervention may be clearly justified for certain types of fits that present distinctive phenomenology and produce high levels of incapacitation. If operator/driver does not recover and assume competent control within a predetermined period of time (especially constrained if destination is not known and potential route inflection points are imminent), vehicle must begin abort to a predetermined state. This predetermined state may in particular be a stop state of the vehicle in a predetermined area of a road or near the road, e.g., in a rest stop or just aside or away from the road. Driver may resume manual operation when he/she is able to do so and the autonomous operation will end accordingly.

In various embodiments, the controller especially is able to detect forms of operator incapacitation which are short in duration and which have distinctive phenomenology, e.g., multiple sneezes and/or some type of epileptic seizure, which, however, is a non-exhaustive and non-limiting exemplary listing.

In various embodiments, the controller brings the vehicle into a predetermined state under certain conditions. Autonomous operation may need to quickly abort, i.e., stop the vehicle, if the intended route is not explicitly set (e.g. using navigation route) or strongly implied (habitual daily/weekly driving patterns) depending on driving context (highway may allow several minutes of autonomous intervention, while inner city may be much shorter).

Unless being indicated as alternatives or referring to another embodiment, any two or more of the embodiments indicated herein may be combined as part of the controller. The functions may be implemented by using hardware modules or as software or functional modules of the controller.

A vehicle is provided that includes a controller for controlling the vehicle. The controller includes an operator monitoring system configured to monitor an operator of the vehicle for a temporary incapacity, and an autonomous driving system configured to operate the vehicle in a temporary autonomous operation mode. The controller further includes a manual driving system configured to operate the vehicle in a manual mode, and a mode determination system configured to transition a current mode of the vehicle between the temporary autonomous operation mode and the manual mode based on the temporary incapacity.

In various embodiments, the operator monitoring system of the vehicle is configured to detect reactions of the operator and to determine if the reaction incapacitates the operator. The operator monitoring system is further configured to generate an operator incapacitation trigger signal for autonomous intervention and to transmit the operator incapacitation trigger signal to the mode determination system if the operator is incapacitated, i.e., cannot at least partially or fully operate the vehicle in a manual operation mode. The autonomous driving system is configured to initiate an autonomous operation mode of the vehicle if the mode determination system receives the operator incapacitation trigger signal and to end the autonomous operation if the operator incapacitation trigger signal ends and if the operator assumes manual control of the vehicle.

It is noted that in various embodiments, the vehicle is modified in accordance with one or multiple of the embodiments described herein with reference to the controller.

A method for controlling a vehicle is provided. The method includes the steps of monitoring an operator of the autonomous vehicle, detecting reactions of the operator and determining if the reactions temporarily incapacitate the operator, generating an operator incapacitation trigger signal if the operator is incapacitated, and transitioning a current mode of the vehicle between the temporary autonomous operation mode and a manual mode based on the operator incapacitation signal.

It is noted that in various embodiments, the method is modified in accordance with the functions of one or more of the embodiments of the controller described herein.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle having a controller, in accordance with an embodiment;

FIG. 2 is a functional block diagram illustrating a transportation system having one or more autonomous vehicles of FIG. 1, in accordance with an embodiment;

FIG. 3 is a functional block diagram illustrating a controller, in accordance with an embodiment;

FIG. 4 is a diagrammatic representation of functional modules of a vehicle, in accordance with an embodiment;

FIG. 5 is a schematic representation of a state transition diagram between the manual and autonomous operation of a vehicle, in accordance with an embodiment; and

FIG. 6 is a schematic representation of a method, in accordance with an embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

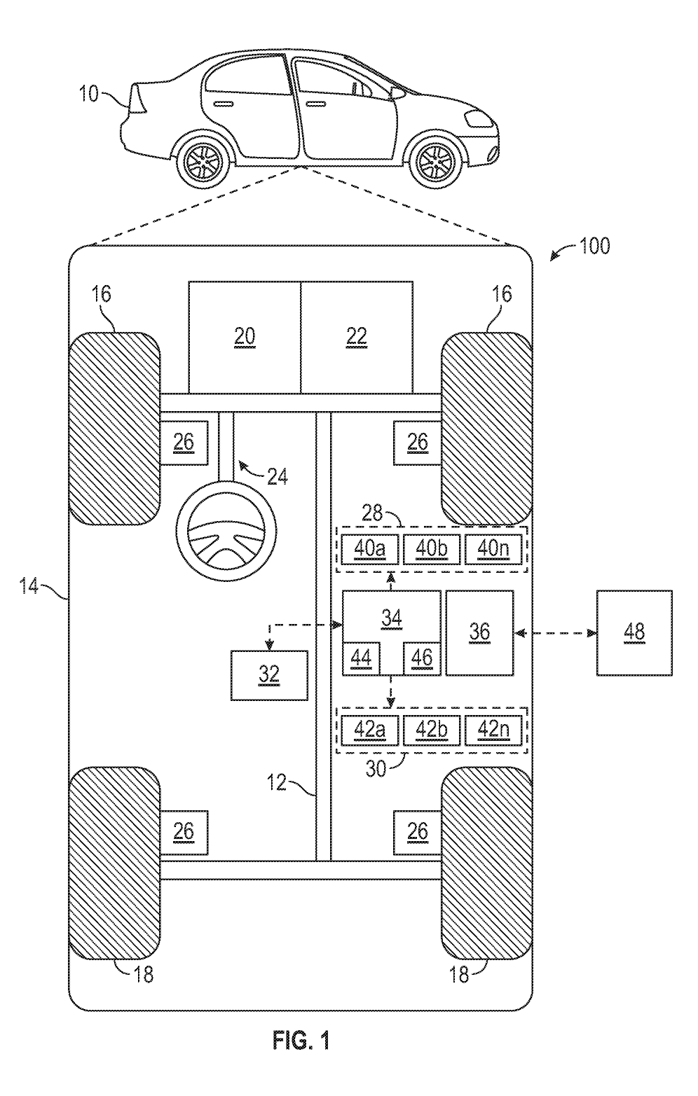

With reference to FIG. 1, a vehicle 10 having a control system 100 is shown in accordance with various embodiments. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16 and 18 are each rotationally coupled to the chassis 12 near a respective corner of the body 14.

In various embodiments, the vehicle 10 is a semi-autonomous vehicle 10 which can be operated in an autonomous mode and a manual mode. Typically, one of these modes is active at a given point of time. In case the manual mode is active and a temporary incapacity of the driver is detected, the vehicle is transitioned to the autonomous mode. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the vehicle 10 implements a so-called Level Four or Level Five automation system which can be operated while the manual mode is not active, i.e., during an autonomous mode. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 an 18 according to selectable speed ratios. According to various embodiments, the transmission system 22 includes a step-ratio automatic transmission, a continuously-variable transmission, or other appropriate transmission. The brake system 26 is configured to provide braking torque to the vehicle wheels 16 and 18. The brake system 26 may, in various embodiments, include friction brakes, brake by wire, a regenerative braking system such as an electric machine, and/or other appropriate braking systems. The steering system 24 influences a position of the of the vehicle wheels 16 and 18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the vehicle 10. The sensing devices 40a-40n include, but are not limited to, radars, lidars, global positioning systems, optical cameras, thermal cameras, ultrasonic sensors, and/or other sensors. The actuator system 30 includes one or more actuator devices 42a-42n that control one or more vehicle features such as, but not limited to, the propulsion system 20, the transmission system 22, the steering system 24, and the brake system 26. In the autonomous mode, the actuator devices control the vehicle features while in the manual mode, the driver does. In various embodiments, the vehicle features can further include interior and/or exterior vehicle features such as, but are not limited to, doors, a trunk, and cabin features such as air, music, lighting, etc. (not numbered). At least some of the sensors of the sensor system are internal microphones, cameras, and/or steering sensors for monitoring the driver for incapacity.

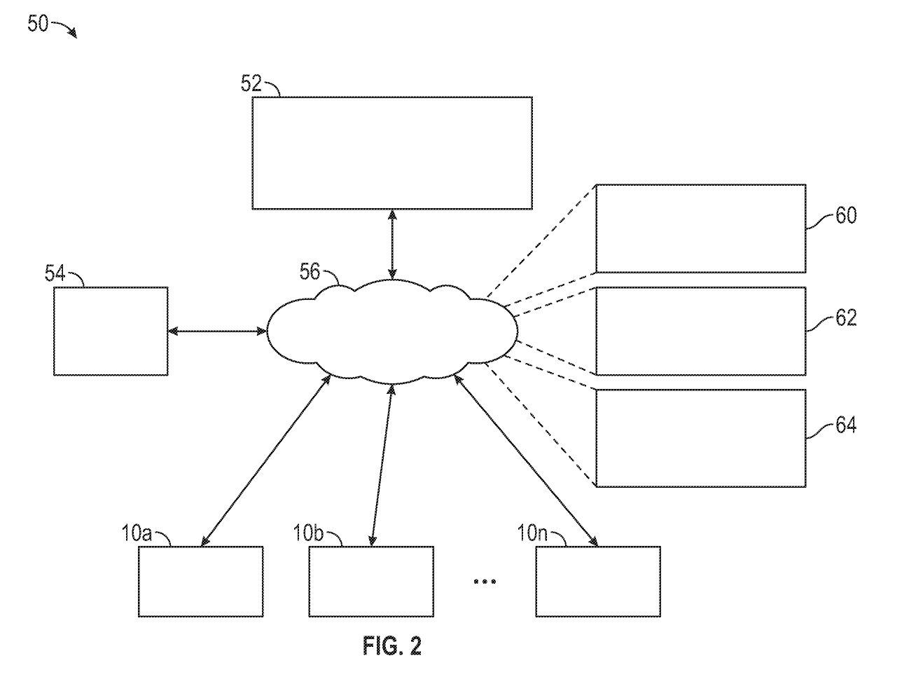

The communication system 36 is configured to wirelessly communicate information to and from other entities 48, such as but not limited to, other vehicles (“V2V” communication,) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication such as LTE (Long Term Evolution) or any other mobile or cellular communication standards. However, additional or alternate communication methods, such as a dedicated short-range communications (DSRC) channel, for example based on the IEEE 802.11p wireless variant, are appropriate in various embodiments and are also considered within the scope of the present disclosure. DSRC channels refer to one-way or two-way short-range to medium-range wireless communication channels specifically designed for automotive use and a corresponding set of protocols and standards for V2V and V2I communications.

The data storage device 32 stores data for use in automatically controlling the vehicle 10 during autonomous mode. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

In various embodiments, one or more instructions of the controller 34 are embodied in the control system 100, and when executed by the processor, effect a vehicle operation transition system 102 that determines temporary operator incapacitation in the vehicle 10 and controls transitions between a manual operating mode and an autonomous operating mode of the vehicle 10. The manual operating mode, for example, relies on operator input to control the vehicle; and the autonomous operating mode, for example, controls the vehicle without any operator input.

With reference now to FIG. 2, in various embodiments, the vehicle 10 described with regard to FIG. 1 is suitable for use in the context of a taxi or shuttle system in a certain geographical area (e.g., a city, a school or business campus, a shopping center, an amusement park, an event center, or the like) or may simply be managed by a remote system, especially when being operated in the autonomous mode. For example, the autonomous vehicle 10 may be associated with an autonomous vehicle based remote transportation system. FIG. 2 illustrates an exemplary embodiment of an operating environment shown generally at 50 that includes an autonomous vehicle based remote transportation system 52 that is associated with one or more autonomous vehicles 10a-10n as described with regard to FIG. 1. In various embodiments, the operating environment 50 further includes one or more user devices 54 that communicate with the autonomous vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 includes a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a piece of home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, which may be cloud-based, network-based, or resident at the particular campus or geographical location serviced by the remote transportation system 52. The remote transportation system 52 can be manned by a live advisor, or an automated advisor, or a combination of both. The remote transportation system 52 can communicate with the user devices 54 and the autonomous vehicles 10a-10n to schedule rides, dispatch autonomous vehicles 10a-10n, and the like. In various embodiments, the remote transportation system 52 stores account information such as subscriber authentication information, vehicle identifiers, profile records, behavioral patterns, and other pertinent subscriber information.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the autonomous vehicles 10a-10n (when and if one is available) to pick up the passenger at the designated pickup location and at the appropriate time. The remote transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline autonomous vehicle 10 and/or an autonomous vehicle based remote transportation system 52. To this end, an autonomous vehicle and autonomous vehicle based remote transportation system can be modified, enhanced, or otherwise supplemented to provide the additional features described in more detail below.

In accordance with various embodiments, controller 34 implements an autonomous driving system (ADS) 70, and a manual driving system (MDS) 71 as shown in FIG. 2. That is, suitable software and/or hardware components of controller 34 (e.g., processor 44 and computer-readable storage device 46) are utilized to provide an autonomous driving system 70 and a manual driving system 71 that are used in conjunction with vehicle 10.

In various embodiments, the sensor fusion system 74 synthesizes and processes sensor data and predicts the presence, location, classification, and/or path of objects and features of the environment of the vehicle 10. In various embodiments, the sensor fusion system 74 can incorporate information from multiple sensors, including but not limited to cameras, lidars, radars, and/or any number of other types of sensors. The computer vision system 74 may also be referred to as a sensor fusion system, as it fuses input from several sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

The vehicle control system 80 is configured to communicate a vehicle control output to the actuator system 30. In an exemplary embodiment, the actuators 42 include a steering control, a shifter control, a throttle control, and a brake control. The steering control may, for example, control a steering system 24 as illustrated in FIG. 1. The shifter control may, for example, control a transmission system 22 as illustrated in FIG. 1. The throttle control may, for example, control a propulsion system 20 as illustrated in FIG. 1. The brake control may, for example, control wheel brake system 26 as illustrated in FIG. 1.

In various embodiments, the controller 34 includes habitual route learning functionality. Thus, the controller 34 recognizes habits depending of an operator/driver, day of the week, time of day, etc. Based on past habits and the course of the current route, the controller 34 identifies a past route to follow in case the autonomous mode is activated. For example, if the current operator, the day of the week, the time of day, and the course of the current route match at least one, preferably multiple, past route and the autonomous mode is activated, the ADS follows the past route.

In the manual driving mode, the driver input is used to control the vehicle and the autonomous driving system is inactive or in a stand-by mode.

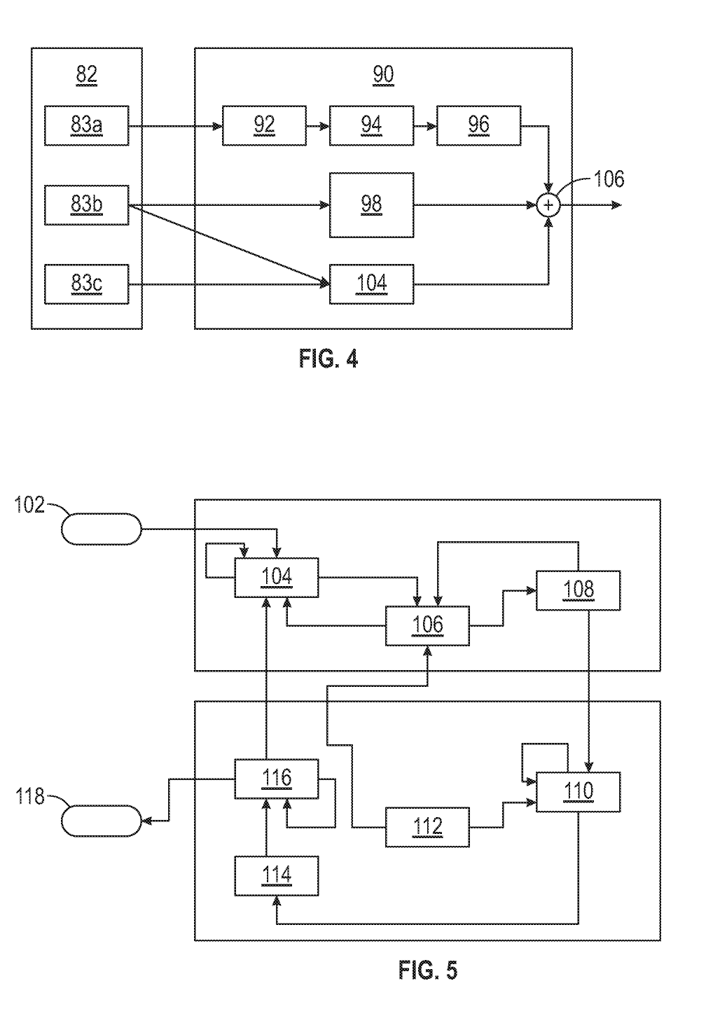

In various embodiments, the vehicle operation transition system 102 is provided which may be part of the controller 34 or may be functionally associated and/or communicatively coupled with the controller 34 and/or with one or multiple of the modules of the driving systems 70, 71. The vehicle operation transition system 102 includes an operator monitoring system 82 (shown in more detail in FIG. 4) and a mode determination system 81 (shown in more detail in FIG. 5) for changing between the autonomous mode and the manual mode, or vice versa.

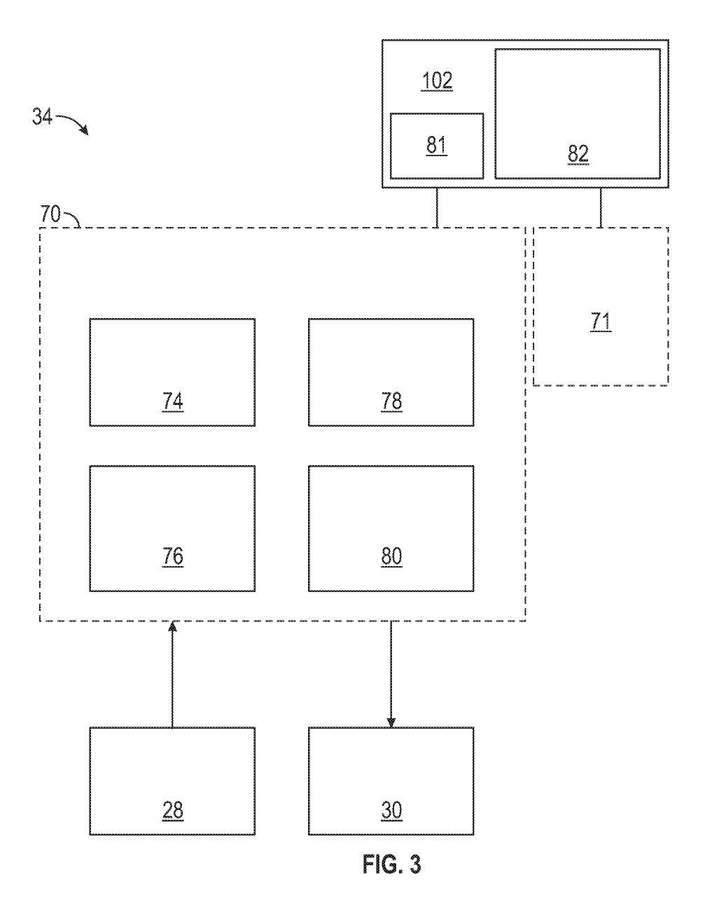

In various embodiments, the instructions of the driving systems 70, 71 may be organized by function or system. For example, as shown in FIG. 3, the autonomous driving system 70 includes a sensor fusion system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

The operator monitoring system 82 determines temporary operator incapacitation in the vehicle 10 based on sensor data and the mode determination system 81 determines a mode or state of the vehicle 10 to be the manual operating mode or the autonomous operating mode and selectively generates signals to the autonomous driving system 70 based on the mode/state. The operator incapacitation signals are among the complete set of signals referred to herein that activate or deactivate autonomous driving as performed by the ADS 70.

For example, with reference to FIG. 4, the operator monitoring system 82 is shown in more detail. The operator monitoring system receives sensor data from internal microphones, cameras, steering system, etc. and determines temporary incapacity of the operator. In various embodiments, the operator monitoring system 82 includes a sound separation and filtering module 92, a repeating sound detection module 94, a sneeze/snore recognizer module 96, a facial expression recognizer module 98, a gesture recognizer module 104, and a summation module 106.

The sound separation and filtering module 92 localizes, filters, and/or recognizes predetermined sound patterns based on distinctive phenomenology of the respective sound.

The repeating sound detection module 94 recognizes and detects repeating sound. The repeating sound detection module 94 recognizes incapacitation based on the interval or time span between two identical or similar sounds. In various embodiments, this interval or time span is individually set or predetermined for each individual sound pattern, i.e., to allow distinguishing between sneezing, coughing, and other types of fits, for example.

A sneeze/snore recognizer module 96 is provided and recognizes the detected sound. Based on the recognized sound, a type of fit may be identified. Camera(s) 83b monitors the operator and provides the captured images to a facial expression recognizer module 98 and a gesture recognizer module 104. A steering feedback unit 83c monitors and detects steering input of the operator and extracts atypical steering motions. The steering motions are input to the gesture recognizer module 104.

Data from the sneeze/snore recognizer module 96, the facial expression recognizer module 98, and the gesture recognizer module 104 are fused and/or cumulated by the summation module 106 of the operator condition detection unit 90 in order to determine if the operator is incapable. If so, a trigger signal is output so that the autonomous driving system assumes autonomous operation of the vehicle.

In particular, the trigger signal for assuming autonomous operation is generated if the detected sound, the facial expression, and the recognized gesture coherently indicate that the operator is distracted. However, the data from the sneeze/snore recognizer module 96, the facial expression recognizer module 98, and the gesture recognizer module 104 may have their individually set weight. The output of these modules may be equally or differently weighted.

In another example, FIG. 5 is a schematic representation of a state transition diagram having a plurality of states within each mode and a plurality of transitions between the states and modes. The state diagram is used to determine the mode/state by the mode determination system 81. For example, the mode determination system 81 begins the operating mode in the manual mode. The manual mode includes at least three states, an autonomous intervention not ready state 104, an autonomous intervention ready state 106, and a trigger condition observed state 108. The autonomous mode includes at least four states, a trigger condition continuing state 110, a trigger condition absent state 112, an abort to minimum risk condition state 114, and a prompt operator state 116.

The mode determination system 81 begins in the autonomous intervention not ready state 104. The mode determination system 81 transitions from the autonomous transition not ready state 104 to the autonomous intervention ready state 106 when operator has opted-in autonomous intervention and, preferably, all essential components of the system indicate operational readiness (e.g. completed self-tests and are determined to be functioning normally).

In the manual mode and the autonomous intervention not ready state 102, the mode determination system 81 maintains state 102 as long as the autonomous intervention is not ready. When the operator of the vehicle has opted-in autonomous intervention at some point and, preferably, the essential components indicate operational readiness, the mode determination system 81 transitions to autonomous intervention ready state 106. In case of system fault detections, mode determination system 81 transitions from autonomous intervention ready state 106 back to autonomous intervention not ready state 104. If a trigger signal from the operator condition detection unit 90 is detected, the mode determination system 81 transitions from autonomous intervention ready state 106 to trigger condition observed state 108. In case the trigger clears, the mode determination system 81 transitions back to state 106.

Once being in state 108 and in case of trigger signal repetition or the trigger signal reaching a predetermined duration limit, the mode determination system 81 activates the autonomous mode and transitions to trigger condition continuing state 110. While the trigger condition continues, the mode determination system 81 maintains state 110 in the autonomous mode and the vehicle is autonomously operated as long as the trigger condition continues, i.e., as long as state 110 is maintained. If the trigger condition clears and the trigger signal is absent, the mode determination system 81 transitions from state 110 to trigger condition absent state 112 while the vehicle is still operated autonomously. In case the operator is responsive and assumes manual control, the mode determination system 81 transitions from state 112 to autonomous intervention ready state 106 of the manual mode.

Being in trigger condition continuing state 110, the mode determination system 81 transitions to abort to minimum risk condition state 114 if a predetermined condition continuing limit is reached or if a system fault is detected. In state 114, the vehicle is autonomously brought into a predetermined state, e.g., to a hold state at the roadside. After this predetermined state (“minimum risk condition”) of the vehicle is achieved, the mode determination system 81 transitions from state 114 to prompt operator state 116. The mode determination system 81 maintains the prompt operator state 116 for a predetermined period of time and repeatedly prompts the operator. If the operator responds and assumes manual control, the mode determination system 81 transitions from state 116 to autonomous intervention not ready state 104. In case the operator does not respond within a predetermined time span, the mode determination system 81 transitions from state 116 to call for assistance state 118 which initiates a call for assistance.

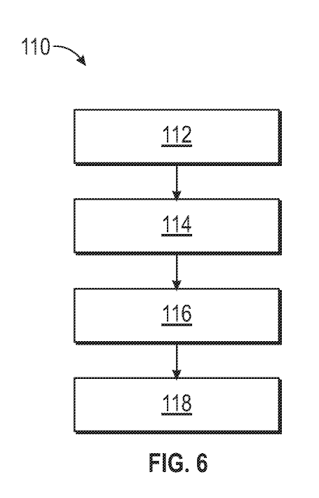

FIG. 6 is a schematic representation of a method 110 for controlling a vehicle. The method includes the steps: monitoring an operator of the autonomous vehicle in step 112; detecting reactions of the operator and determining if the reactions temporarily incapacitate the operator in step 114; generating an operator incapacitation trigger signal if the operator is incapacitated in step 116; and in step 118 transitioning a current mode of the vehicle between the temporary autonomous operation mode and a manual mode based on the operator incapacitation signal. In particular, the method 110 schematically shown in FIG. 6 is implemented in a controller 34 described with reference to various embodiments herein.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A controller for controlling a vehicle, comprising:
an operator monitoring system configured to monitor an operator of the vehicle for a temporary incapacity;
an autonomous driving system configured to operate the vehicle in a temporary autonomous operation mode;
a manual driving system configured to operate the vehicle in a manual mode; and
a mode determination system configured to transition a current mode of the vehicle between the temporary autonomous operation mode and the manual mode based on the temporary incapacity.

2. The controller of claim 1,
wherein the operator monitoring system is configured to detect reactions of the operator and to determine if the reaction temporary incapacitates the operator;
wherein the operator monitoring system is configured to generate an operator incapacitation trigger signal for autonomous intervention and to transmit the operator incapacitation trigger signal to the mode determination system if the operator is incapacitated;
wherein the mode determination system is configured to initiate an autonomous operation mode of the vehicle if the mode determination system receives the operator incapacitation trigger signal and to end the autonomous operation if the operator incapacitation trigger signal ends and if the operator assumes manual control of the vehicle.

3. The controller of claim 1,
wherein the autonomous driving system is configured to determine if an intended route of the vehicle is present and to follow the intended route if it is present or, otherwise, to bring the vehicle to a predetermined state if there is no intended route present.

4. The controller of claim 3,
wherein the autonomous driving system is configured to determine if the intended route is explicitly set; or
wherein the autonomous driving system is configured to imply the intended route based on past driving patterns.

5. The controller of claim 1,
wherein the autonomous driving system is configured to determine a driving context and to bring the vehicle to a predetermined state based on the determined driving context.

6. The controller of claim 1, wherein the operator monitoring system comprises:
at least one sensor of a group of operator monitor sensors consisting of: a microphone, a camera, a steering feedback sensor;
wherein the at least one sensor is positioned to detect operator reactions onboard the vehicle.

7. The controller of claim 1,
wherein the operator monitoring system comprises at least two microphones positioned and configured to enable detecting a position of a noise source for distinguishing between different possible operator positions.

8. The controller of claim 6,
wherein the operator monitoring system is configured to detect operator incapacitation based on a signal of the at least one sensor.

9. The controller of claim 2,
wherein the operator monitoring system is configured to repeatedly generate the operator incapacitation trigger signal if the operator is incapacitated;
wherein the mode determination system is configured to initiate the autonomous operation mode after a predetermined trigger repetition or after a predetermined trigger duration.

10. The controller of claim 3,
wherein the autonomous driving system is configured to generate a call for assistance signal and to transmit the call for assistance signal to a communication system after bringing the vehicle to the predetermined state and if the operator incapacitation trigger signal is still present for a predetermined time duration or if the operator does not respond within the predetermined time duration.

11. A vehicle, comprising a controller for controlling the vehicle, the controller comprising:
an operator monitoring system configured to monitor an operator of the vehicle for a temporary incapacity;
an autonomous driving system configured to operate the vehicle in a temporary autonomous operation mode;
a manual driving system configured to operate the vehicle in a manual mode; and
a mode determination system configured to transition a current mode of the vehicle between the temporary autonomous operation mode and the manual mode based on the temporary incapacity.

12. The vehicle of claim 11,
wherein the operator monitoring system is configured to detect reactions of the operator and to determine if the reaction temporary incapacitates the operator;
wherein the operator monitoring system is configured to generate an operator incapacitation trigger signal for autonomous intervention and to transmit the operator incapacitation trigger signal to the mode determination system if the operator is incapacitated;
wherein the mode determination system is configured to initiate an autonomous operation mode of the vehicle if the mode determination system receives the operator incapacitation trigger signal and to end the autonomous operation if the operator incapacitation trigger signal ends and if the operator assumes manual control of the vehicle.

13. The vehicle of claim 11,
wherein the autonomous driving system is configured to determine if an intended route of the vehicle is present and to follow the intended route if it is present or, otherwise, to bring the vehicle to a predetermined state if there is no intended route present.

14. The vehicle of claim 13,
wherein the autonomous driving system is configured to determine if the intended route is explicitly set; or,
wherein the autonomous driving system is configured to imply the intended route based on past driving patterns.

15. The vehicle of claim 11,
wherein the autonomous driving system is configured to determine a driving context and to bring the vehicle to a predetermined state based on the determined driving context.

16. The vehicle of claim 11, wherein the operator monitoring system comprises:
at least one sensor of a group of operator monitor sensors consisting of: a microphone, a camera, a steering feedback sensor;
wherein the at least one sensor is positioned to detect operator reactions onboard the vehicle,
wherein the operator monitoring system is configured to detect operator incapacitation based on a signal of the at least one sensor.

17. The vehicle of claim 11,
wherein the operator monitoring system comprises at least two microphones positioned and configured to enable detecting a position of a noise source for distinguishing between different possible operator positions.

18. The vehicle of claim 12,
wherein the operator monitoring system is configured to repeatedly generate the operator incapacitation trigger signal if the operator is incapacitated;
wherein the mode determination system is configured to initiate the autonomous operation mode after a predetermined trigger repetition or after a predetermined trigger duration.

19. The vehicle of claim 13,
wherein the autonomous driving system is configured to generate a call for assistance signal and to transmit the call for assistance signal to a communication system after bringing the vehicle to the predetermined state and if the operator incapacitation trigger signal is still present for a predetermined time duration or if the operator does not respond within the predetermined time duration.

20. A method for controlling a vehicle, comprising the steps of:
monitoring an operator of the autonomous vehicle;
detecting reactions of the operator and determining if the reactions temporarily incapacitate the operator;
generating an operator incapacitation trigger signal if the operator is incapacitated; and
transitioning a current mode of the vehicle between the temporary autonomous operation mode and a manual mode based on the operator incapacitation signal.
